(19) United States
(12) Patent Application Publication
(10) Pub. No.: US 2020/0164550 A1
(43) Pub. Date: May 28, 2020

(54) MANUFACTURING METHOD FOR COMPOSITE MEMBER

(71) Applicant: TOYOTA JIDOSHA KABUSHIKI KAISHA, Toyota-shi (JP)

(72) Inventors: Takayuki KAWANO, Toyota-shi (JP); Toshinori NAKAKURA, Nagakute-shi (JP); Tadashi HIDEHIRA, Toyota-shi (JP); Masashi IWAKIRI, Toyota-shi (JP); Makoto FUKUNISHI, Okazaki-shi (JP)

(73) Assignee: TOYOTA JIDOSHA KABUSHIKI KAISHA, Toyota-shi (JP)

(21) Appl. No.: 16/657,053

(22) Filed: Oct. 18, 2019

(30) Foreign Application Priority Data
Nov. 27, 2018 (JP) 2018-221383

(51) Int. Cl. B29C 44/12; B29C 51/10; B29C 51/14; B29C 44/42; B29C 44/08

(52) U.S. Cl. CPC B29C 44/1271; B29C 51/10; B29L 2031/3005; B29C 44/42; B29C 44/086; B29C 51/14

(57) ABSTRACT

A manufacturing method for a composite member according to one aspect of the disclosure includes: a step of forming a substrate sheet by forming a coating layer on a first surface of a resin sheet and drying the substrate sheet by heat; a step of molding the substrate sheet by use of a first mold by heating the substrate sheet; and a step of forming a foaming resin layer on a second surface of the resin sheet by use of a second mold after the substrate sheet is molded, the second surface being an opposite side from the first surface of the resin sheet.

### INCORPORATION BY REFERENCE

The disclosure of Japanese Patent Application No. 2018-221383 filed on Nov. 27, 2018 including the specification, drawings and abstract is incorporated herein by reference in its entirety.

### BACKGROUND

### 1. Technical Field

This disclosure relates to a manufacturing method for a composite member.

### 2. Description of Related Art

An inner panel of an automobile or the like, for example, has a configuration in which a resin sheet and a foam sheet are laminated. Such an inner panel is formed in such a manner that the resin sheet is heated and put along a first mold, the foam sheet is heated and put along a second mold, and then, the first mold and the second mold are closed, so that the resin sheet and the foam sheet are laminated and attached to each other by pressure and heat, as described in Japanese Unexamined Patent Application Publication No. 2017-210151 (JP 2017-210151 A), for example.

### SUMMARY

The applicants found the following problem. The inner panel described in JP 2017-210151 A is configured as a composite member in which the resin sheet and the foam sheet are laminated. In a case where coating is performed on a surface of such a composite member, it is necessary to dry, by heat, the composite member on which a coating layer is formed. However, there is such a problem that the foam sheet deteriorates at the time when the composite member on which the coating layer is formed is dried by heat.

This disclosure has been accomplished in consideration of such a problem and is to achieve a manufacturing method for a composite member that can restrain deterioration of a foaming resin layer.

A manufacturing method for a composite member according to one aspect of this disclosure includes: a step of forming a substrate sheet by forming a coating layer on a first surface of a resin sheet and drying the substrate sheet by heat; a step of molding the substrate sheet by use of a first mold by heating the substrate sheet; and a step of forming a foaming resin layer on a second surface of the resin sheet by use of a second mold after the substrate sheet is molded, the second surface being an opposite side from the first surface of the resin sheet. As such, the substrate sheet is formed by forming the coating layer on the resin sheet, and after the substrate sheet is dried by heat, the foaming resin layer is formed on the substrate sheet. This makes it possible to restrain deterioration of the foaming resin layer.

In the manufacturing method of the above aspect, the substrate sheet after the molding may have a rigidity with which the substrate sheet does not maintain a shape of the substrate sheet by itself when the substrate sheet is unmolded from the first mold. The substrate sheet after the molding may be held by a cavity surface of the first mold or the second mold at least after the molding of the substrate sheet has been completed but before the formation of the foaming resin layer is started. Hereby, the deformation of the substrate sheet can be restrained at the time when the foaming resin layer is formed, thereby making is possible to manufacture the composite member with high accuracy.

In the manufacturing method of the above aspect, a temperature of the substrate sheet after the molding of the substrate sheet is started but before injection of foaming resin into a cavity of the second mold to form the foaming resin layer is completed may not become lower than a temperature of the substrate sheet when the injection of the foaming resin has been completed.

The manufacturing method of the above aspect may further include a step of joining a functional member to the second surface of the resin sheet after the substrate sheet is molded. In the step of forming the foaming resin layer, the foaming resin layer may be formed by injecting foaming resin into a cavity of the second mold in a state where the substrate sheet to which the functional member is joined is placed inside the cavity of the second mold. This makes it possible to easily manufacture the composite member including the functional member at low cost.

The disclosure can achieve a manufacturing method for a composite member that can restrain deterioration of a foaming resin layer.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1A is a view to describe the procedure of a manufacturing method for a composite member according to a first embodiment;

FIG. 1B is a view to describe the procedure of the manufacturing method for the composite member according to the first embodiment;

FIG. 1C is a view to describe the procedure of the manufacturing method for the composite member according to the first embodiment;

FIG. 1D is a view to describe the procedure of the manufacturing method for the composite member according to the first embodiment;

FIG. 1E is a view to describe the procedure of the manufacturing method for the composite member according to the first embodiment;

FIG. 2 is a sectional view schematically illustrating a substrate sheet of the composite member in the first embodiment;

FIG. 3 is a sectional view schematically illustrating a different substrate sheet of the composite member in the first embodiment;

FIG. 4 is a view illustrating a temperature change in the substrate sheet in the manufacturing method for the composite member according to the first embodiment;

FIG. 5A is a view to describe the procedure of a manufacturing method for a composite member according to a second embodiment;

FIG. 5B is a view to describe the procedure of the manufacturing method for the composite member according to the second embodiment;

FIG. 5C is a view to describe the procedure of the manufacturing method for the composite member according to the second embodiment;

FIG. 5D is a view to describe the procedure of the manufacturing method for the composite member according to the second embodiment;

FIG. 6A is a view to describe the procedure of a manufacturing method for a composite member according to a third embodiment;

FIG. 6B is a view to describe the procedure of the manufacturing method for the composite member according to the third embodiment;

FIG. 6C is a view to describe the procedure of the manufacturing method for the composite member according to the third embodiment;

FIG. 7 is a view illustrating a temperature change in a substrate sheet in a manufacturing method for a composite member according to a fourth embodiment;

FIG. 8A is a view to describe the procedure of a manufacturing method for a composite member according to a fifth embodiment;

FIG. 8B is a view to describe the procedure of the manufacturing method for the composite member according to the fifth embodiment;

FIG. 8C is a view to describe the procedure of the manufacturing method for the composite member according to the fifth embodiment;

FIG. 8D is a view to describe the procedure of the manufacturing method for the composite member according to the fifth embodiment; and

FIG. 8E is a view to describe the procedure of the manufacturing method for the composite member according to the fifth embodiment.

### DETAILED DESCRIPTION OF EMBODIMENTS

The following describes concrete embodiments to which this disclosure is applied in detail with reference to the drawings. Note that this disclosure is not limited to the following embodiments. Further, the following description and drawings are simplified appropriately for clarification of the description.

### First Embodiment

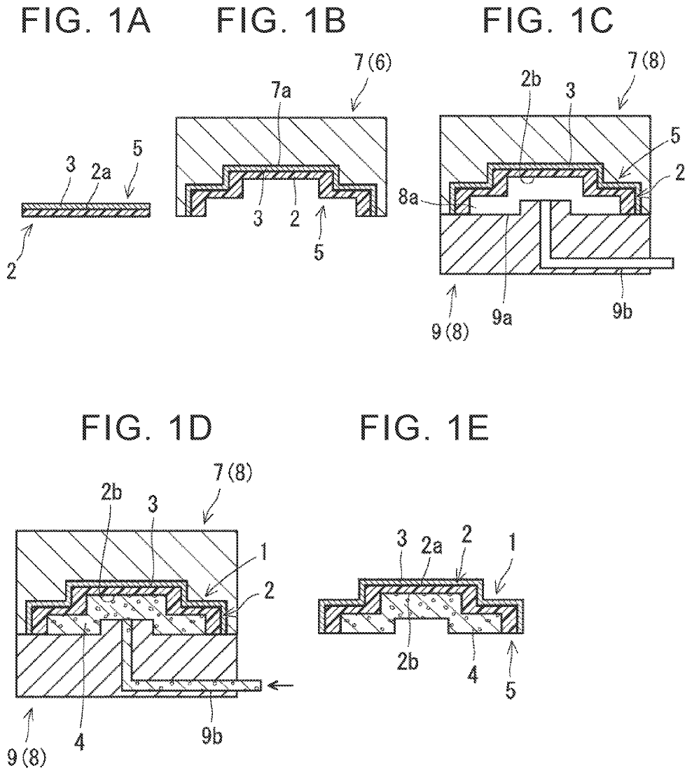

FIGS. 1A to 1E are views to describe the procedure of a manufacturing method for a composite member according to the present embodiment. A manufacturing method for a composite member 1 (see FIG. 1E) in the present embodiment is suitable for manufacture of a roof, a door, an engine hood, a trunk, or the like as an exterior part of a vehicle, for example. Note that the purpose of the composite member 1 is not limited.

Here, the present embodiment deals with a case where a laminated body in which a coating layer 3 is formed on a top face (a first surface) 2a of a resin sheet 2, and a foaming resin layer 4 is formed on a bottom face (a second surface) 2b of the resin sheet 2 is manufactured as the composite member 1. Note that, in the following description, in order to clarify the description, the up-down direction is defined based on the placement of the resin sheet 2 before molding, but the placement of the resin sheet 2 is not limited.

First, as illustrated in FIG. 1A, a substrate sheet 5 is formed by forming the coating layer 3 on the top face 2a of the resin sheet 2, and after that, the substrate sheet 5 is dried by heat so as to dry the coating layer 3. The resin sheet 2 is a sheet material such as a polyvinyl chloride (PVC) based sheet material, a polypropylene (PP) based sheet material, a polymethyl methacrylate (PMMA) based sheet material, an acrylonitrile-butadiene-styrene (ABS) based sheet material, an acrylonitrile-styrene-acrylate (ASA) based sheet material, an acrylonitrile-ethylene-styrene (AES) based sheet material, or a polycarbonate (PC) based sheet material.

A material for the resin sheet 2 can be selected appropriately in accordance with the purpose of the composite member 1 and the like, and in a case where the composite member 1 is used as an exterior part of a vehicle, for example, the material should be an ABS based sheet material, an ASA based sheet material, or an AES based sheet material in consideration of a heat resistance or a sliding characteristic in an after-mentioned manufacturing process, a weather resistance or an impact resistance at the time of the use of the composite member 1, or the like.

A thickness of the resin sheet 2 can be set appropriately in accordance with the purpose of the composite member 1 and the like, and in a case where the composite member 1 is used as an exterior part of a vehicle, for example, the thickness of the resin sheet 2 is 0.5 mm to 1.5 mm and preferably 0.8 mm to 1.2 mm.

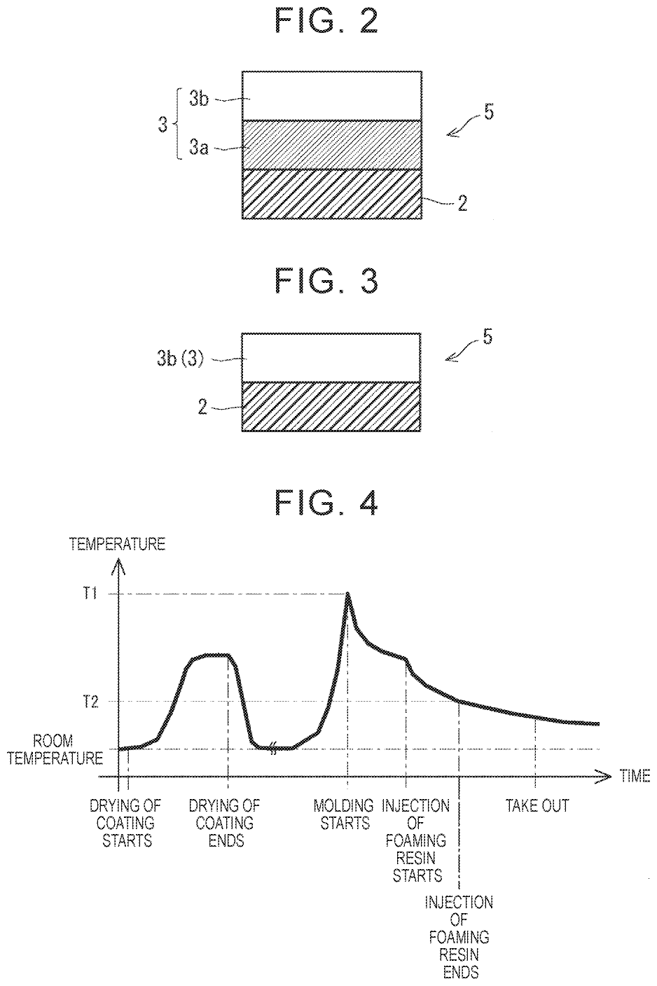

FIG. 2 is a sectional view schematically illustrating a substrate sheet of the composite member in the present embodiment. FIG. 3 is a sectional view schematically illustrating a different substrate sheet of the composite member in the present embodiment. The coating layer 3 may include a pigmented layer 3a and a clear layer 3b as illustrated in FIG. 2 or may include only the clear layer 3b as illustrated in FIG. 3. Needless to say, the coating layer 3 may include only the pigmented layer 3a. The number of layers such as the pigmented layer 3a and the clear layer 3b can be set appropriately,

The coating layer 3 can be formed by general spray coating, but since the resin sheet 2 is a sheet material, the coating layer 3 can be formed by use of general surface printing coating such as screen printing, inkjet printing, or roll coating. In a case where the coating layer 3 is formed by screen printing, decorating or the like can be performed while the thickness of the coating layer 3 is managed appropriately.

A material for the coating layer 3 and the thickness of the coating layer 3 may be set appropriately in accordance with a heat resistance or a sliding characteristic in the after-mentioned manufacturing process, the purpose of the composite member 1, or the like. In a case where the composite member 1 is used as an exterior part of a vehicle, for example, the thickness of the coating layer 3 is 25 μm to 100 μm and preferably 10 μm to 50 μm. A heat resistant temperature of the coating layer 3 should be set in accordance with a heating temperature at the time of molding of the substrate sheet 5 as will be described later.

Subsequently, the substrate sheet 5 is heated in a state where the substrate sheet 5 is tensed generally horizontally by use of a jig (not shown), for example, and the substrate sheet 5 is molded by use of a first mold 6, as illustrated in FIG. 1B. The first mold 6 of the present embodiment includes a recessed mold 7, and the substrate sheet 5 is molded in vacuum by use of the recessed mold 7. That is, the first mold 6 is a mold to be used at the time of molding the substrate sheet 5.

More specifically, the recessed mold 7 includes a recessed cavity surface 7a provided on a bottom face of the recessed mold 7 so as to correspond to an outer shape (that is, a front surface) of a component for which the composite member 1 is used, and a suction path (not shown). A first end of the suction path reaches the cavity surface 7a, and a second end of the suction path is connected to a suction pump.

The heated substrate sheet 5 is placed so that the coating layer 3 of the substrate sheet 5 faces the cavity surface 7a of the recessed mold 7. That is, the substrate sheet 5 is placed under the recessed mold 7. Note that, after the substrate sheet 5 is placed under the recessed mold 7, the substrate sheet 5 may be heated. After that, air is sucked up through the suction path of the recessed mold 7, so that the substrate sheet 5 is adsorbed to be put along the cavity surface 7a of the recessed mold 7. Thus, the substrate sheet 5 is molded.

Subsequently, as illustrated in FIG. 1C, in order to form the foaming resin layer 4 (see FIG. 1D) on a bottom face of the substrate sheet 5 (that is, the bottom face 2b of the resin sheet 2), a second mold 8 is closed. The second mold 8 is a mold to be used at the time of forming the foaming resin layer 4, and in the present embodiment, the second mold 8 includes the recessed mold 7 and a lower mold 9. That is, the recessed mold 7 is commonly used for the first mold 6 and the second mold 8.

The lower mold 9 includes a cavity surface 9a provided on a top face of the lower mold 9 so as to correspond to an inner shape (that is, a back surface) of the component for which the composite member 1 is used, and an injection path 9b. A first end of the injection path 9b reaches the cavity surface 9a, and a second end of the injection path is connected to an injection pump for foaming resin.

Here, in a case where the substrate sheet 5 is a thin sheet material (e.g., about 1 mm) having a flexibility, the substrate sheet 5 after the molding may have a rigidity with which the substrate sheet 5 cannot maintain its shape by itself at the time when the substrate sheet 5 is unmolded from the recessed mold 7. That is, the substrate sheet 5 after the molding might not be able to maintain its shape after the molding by the rigidity of the substrate sheet 5 and might deform by deadweight.

In view of this, in the present embodiment, at least after the molding of the substrate sheet 5 has been completed but before the formation of the foaming resin layer 4 is started, the substrate sheet 5 after the molding is adsorbed and held by the cavity surface 7a of the recessed mold 7. That is, while a state where the substrate sheet 5 is held by the cavity surface 7a of the recessed mold 7 is maintained after the molding of the substrate sheet 5, the recessed mold 7 and the lower mold 9 are closed.

As such, at the time when a molding step of the substrate sheet 5 is shifted to a forming step of the foaming resin layer 4, the substrate sheet 5 is held by the cavity surface 7a of the recessed mold 7 without unmolding the substrate sheet 5 from the recessed mold 7, thereby making it possible to maintain the substrate sheet 5 in a molded shape. That is, it is possible to restrain deformation of the substrate sheet 5.

Subsequently, as illustrated in FIG. 1D, the foaming resin layer 4 is formed on the bottom face 2b of the resin sheet 2 by use of the second mold 8. More specifically, foaming resin is injected into a cavity 8a of the second mold 8 through the injection path 9b of the lower mold 9, so that the foaming resin layer 4 is formed on the bottom face 2b of the resin sheet 2. Hereby, the composite member 1 that is a laminated body in which the foaming resin layer 4, the resin sheet 2, and the coating layer 3 are laminated from bottom to top is formed.

After that, the recessed mold 7 and the lower mold 9 are opened, and the composite member 1 as illustrated in FIG. 1E is taken out. Here, the manufacture of the composite member 1 is finished.

As such, in the manufacturing method for the composite member 1 in the present embodiment, the substrate sheet 5 is formed by forming the coating layer 3 on the resin sheet 2, and after the substrate sheet 5 is dried by heat, the foaming resin layer 4 is formed on the substrate sheet 5. On this account, it is possible to restrain deterioration of the foaming resin layer 4.

Besides, the composite member 1 is configured such that the substrate sheet 5 is reinforced by the foaming resin layer 4, so that the resin sheet 2 can be thinned. Accordingly, while a weight reduction of the composite member 1 is achieved, the composite member 1 can be manufactured at low cost. Further, the substrate sheet 5 can be reduced in thickness, and at the time when the substrate sheet 5 is heated to mold the substrate sheet 5, the temperature of the substrate sheet 5 can be quickly stabilized to be generally uniform. On that account, the substrate sheet 5 can be molded with accuracy. Further, since the temperature of the substrate sheet 5 can be stabilized, an overheating part can hardly occur in the substrate sheet 5, and the temperature of the substrate sheet 5 can be easily controlled to be not more than a heat resistant temperature of the coating layer 3, so that the coating layer 3 can be hardly damaged by overheating.

Further, in a case where the substrate sheet 5 after the molding is held by the cavity surface 7a of the recessed mold 7 at least after the molding of the substrate sheet 5 has been completed but before the formation of the foaming resin layer 4 is started, the deformation of the substrate sheet 5 can be restrained, thereby resulting in that the composite member 1 can be manufactured with high accuracy.

Next will be described a temperature change of the substrate sheet 5 in the manufacturing method for the composite member 1 in the present embodiment. FIG. 4 is a view illustrating a temperature change of a substrate sheet in the manufacturing method for the composite member in the present embodiment.

In the manufacturing method for the composite member 1 in the present embodiment, for example, the substrate sheet 5 is formed by forming the coating layer 3 on the resin sheet 2 in a coating facility in a manufactory for the composite member 1, and after the substrate sheet 5 is dried by heat, the substrate sheet 5 thus dried by heat is transferred to a molding facility separated from the coating facility in the manufactory, so that the molding step of the substrate sheet 5 and the forming step of the foaming resin layer 4 are performed.

At this time, as illustrated in FIG. 4, the temperature of the substrate sheet 5 rises at the time when the substrate sheet 5 is dried by heat. While heat drying of the substrate sheet 5 is completed and the substrate sheet 5 is transferred from the coating facility to the molding facility in the manufactory, the temperature of the substrate sheet 5 decreases to the room temperature of the manufactory.

Then, in order to mold the substrate sheet 5 in the molding facility, the substrate sheet 5 is heated to a preset temperature T1. When molding of the substrate sheet 5 is started, heating of the substrate sheet 5 is stopped, so that the temperature of the substrate sheet 5 decreases.

After that, the molding step of the substrate sheet 5 is shifted to the forming step of the foaming resin layer 4. However, in the manufacturing method for the composite member 1 in the present embodiment, after the molding step of the substrate sheet 5, the forming step of the foaming resin layer 4 is performed without unmolding the substrate sheet 5 from the recessed mold 7 and transferring the substrate sheet 5 to a facility different from the molding facility.

On this account, in the manufacturing method for the composite member 1 in the present embodiment, the temperature of the substrate sheet 5 does not decrease to the room temperature of the manufactory between the molding step of the substrate sheet 5 and the forming step of the foaming resin layer 4, and the temperature from molding start of the substrate sheet 5 (that is, a time when suction of the air is started through the suction path of the recessed mold 7) until completion of injection of the foaming resin into the cavity 8a of the second mold 8 (that is, a time when the foaming resin with a preset injection amount has been injected) does not become lower than a temperature T2 at the time when the injection of the foaming resin into the cavity 8a of the second mold 8 is completed.

As such, in the manufacturing method for the composite member 1 in the present embodiment, the molding step of the substrate sheet 5 and the forming step of the foaming resin layer 4 can be performed continuously. This makes it possible to shorten a manufacturing time for the composite member 1 and to improve productivity of the composite member 1. Besides, it is possible to form the foaming resin layer 4 by use of heat of the substrate sheet 5 at the time when the substrate sheet 5 is molded, thereby making it possible to restrain an energy loss.

### Second Embodiment

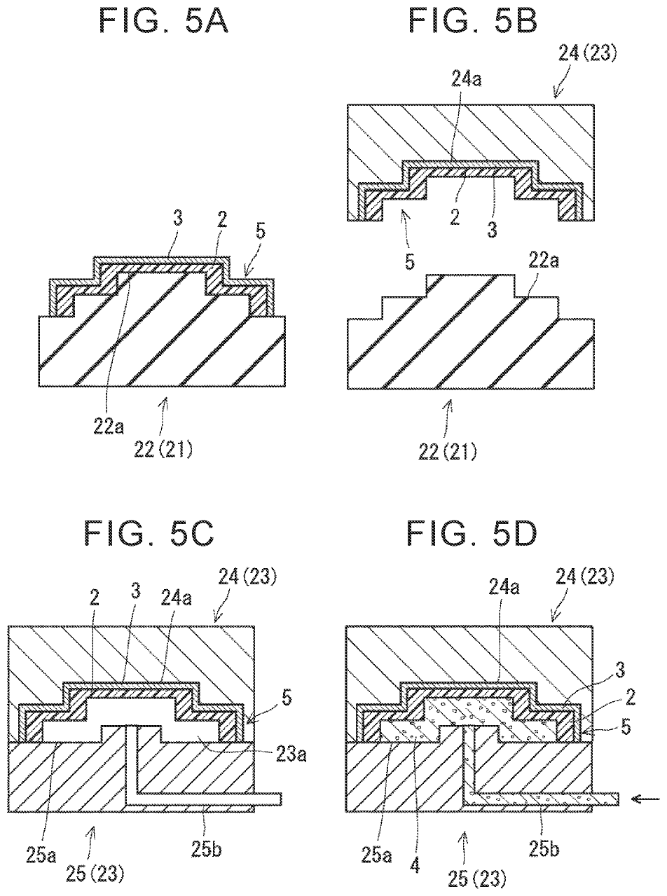

FIGS. 5A to 5D are views to describe the procedure of a manufacturing method for a composite member according to the present embodiment. Note that, in the following description, descriptions that have been made in the manufacturing method for the composite member 1 in the first embodiment are omitted, and a member equivalent to a member in the first embodiment will be described with the same reference sign as the reference sign assigned to the member in the first embodiment. Further, the substrate sheet 5 and the composite member 1 of the present embodiment are the same as the substrate sheet 5 and the composite member 1 of the first embodiment, and therefore, illustrations corresponding to FIGS. 1A and 1E are omitted in FIGS. 5A to 5D.

In the manufacturing method for the composite member 1 in the present embodiment, the substrate sheet 5 is molded in vacuum by use of a projecting mold 22 as a first mold 21 as illustrated in FIG. 5A. The projecting mold 22 includes a projecting cavity surface 22a provided on a top face of the projecting mold 22 so as to correspond to an outer shape of a component for which the composite member 1 is used, and a suction path (not shown). A first end of the suction path reaches the cavity surface 22a, and a second end of the suction path is connected to a suction pump.

In a case where the substrate sheet 5 is molded by use of the projecting mold 22, the heated substrate sheet 5 is placed so that the bottom face of the substrate sheet 5 faces the cavity surface 22a of the projecting mold 22, or the substrate sheet 5 is heated after the substrate sheet 5 is placed so that the bottom face of the substrate sheet 5 faces the cavity surface 22a. That is, the substrate sheet 5 is placed on the projecting mold 22.

Subsequently, the air is sucked up through the suction path, so that the substrate sheet 5 is adsorbed to be put along the cavity surface 22a of the projecting mold 22. Thus, the substrate sheet 5 is molded. That is, the substrate sheet 5 is molded such that the bottom face of the substrate sheet 5 is put along the cavity surface 22a of the projecting mold 22, the bottom face being an opposite side from the top face on which the coating layer 3 is formed

Then, the foaming resin layer 4 is formed on the bottom face 2b of the resin sheet 2 by use of a second mold 23. More specifically, the second mold 23 of the present embodiment includes an upper mold 24 and a lower mold 25 as illustrated in FIG. 5C.

The upper mold 24 includes a recessed cavity surface 24a provided on a bottom face of the upper mold 24 so as to correspond to the outer shape of the component for which the composite member 1 is used, and a suction path (not shown). A first end of the suction path reaches the cavity surface 24a, and a second end of the suction path is connected to a suction pump.

The lower mold 25 includes a cavity surface 25a provided on a top face of the lower mold 25 so as to correspond to an inner shape of the component for which the composite member 1 is used, and an injection path 25b. A first end of the injection path 25b reaches the cavity surface 25a, and a second end of the injection path 25b is connected to an injection pump for foaming resin.

In a case where the foaming resin layer 4 is formed on the bottom face 2b of the resin sheet 2 by use of such a second mold 23, the cavity surface 24a of the upper mold 24 relatively comes closer to the cavity surface 22a of the projecting mold 22 while a state where the substrate sheet 5 is adsorbed to the cavity surface 22a of the projecting mold 22 is maintained, and the cavity surface 24a of the upper mold 24 is generally brought into contact with the cavity surface 22a of the projecting mold 22 via the substrate sheet 5.

Then, as illustrated in FIG. 5B, the state where the substrate sheet 5 is adsorbed and held by the cavity surface 22a of the projecting mold 22 is shifted to a state where the substrate sheet 5 is adsorbed and held by the cavity surface 24a of the upper mold 24, so that the upper mold 24 is relatively distanced from the projecting mold 22. Hereby, the substrate sheet 5 can be moved from the projecting mold 22 to the upper mold 24.

Subsequently, while the state where the substrate sheet 5 is adsorbed and held by the cavity surface 24a of the upper mold 24 is maintained, the upper mold 24 and the lower mold 25 are closed as illustrated in FIG. 5C. Then, while the state where the substrate sheet 5 is adsorbed and held by the cavity surface 24a of the upper mold 24 is maintained, foaming resin is injected into a cavity 23a of the second mold 23 through the injection path 25b of the lower mold 25, so that the foaming resin layer 4 is formed on the bottom face 2b of the resin sheet 2, as illustrated in FIG. 5D.

At this time, the substrate sheet 5 should be adsorbed and held by the cavity surface 24a of the upper mold 24 at least until the injection of the foaming resin is started. As such, at least after the molding of the substrate sheet 5 has been completed but before the formation of the foaming resin layer 4 is started, the substrate sheet 5 after the molding is adsorbed and held by the cavity surface 22a of the projecting mold 22 or the cavity surface 24a of the upper mold 24.

On this account, even in a case where the substrate sheet 5 is a thin sheet material having a flexibility, the shape of the substrate sheet 5 is maintained by the projecting mold 22 or the upper mold 24 after the molding of the substrate sheet 5 has been completed but before the formation of the foaming resin layer 4 is started. Accordingly, it is possible to restrain deformation of the substrate sheet 5 at the time when the molding step of the substrate sheet 5 is shifted to the forming step of the foaming resin layer 4, so that the composite member 1 can be manufactured with accuracy.

After that, the upper mold 24 and the lower mold 25 are opened, and the composite member 1 as a laminated body is taken out. Here, the manufacture of the composite member 1 is finished.

In the manufacturing method for the composite member 1 in the present embodiment, the substrate sheet 5 is molded such that the bottom face of the substrate sheet 5 is put along the cavity surface 22a of the projecting mold 22, the bottom face being an opposite side from the top face on which the coating layer 3 is formed. This makes it possible to reduce damage to the coating layer 3.

### Third Embodiment

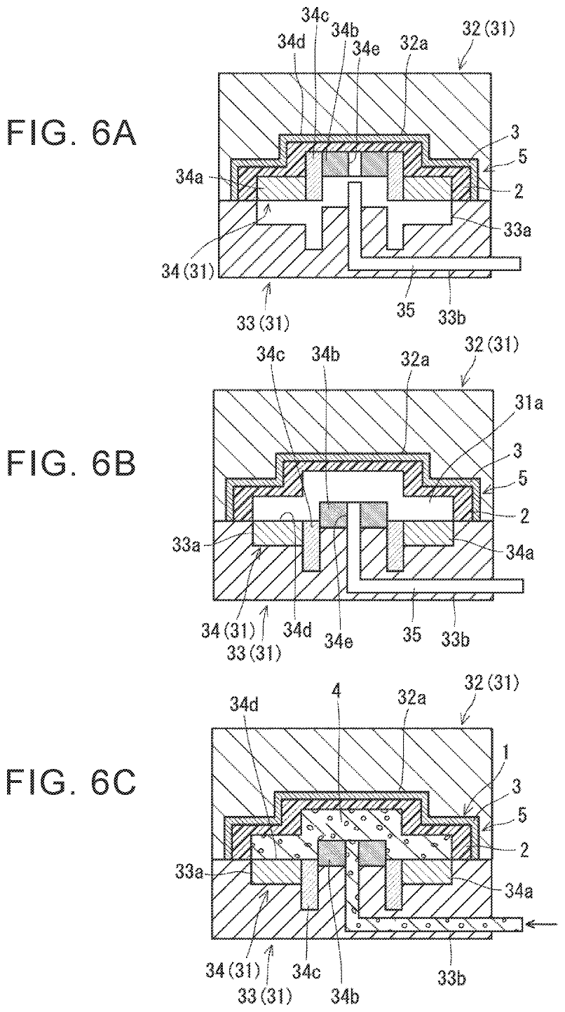

In the manufacturing methods for the composite member 1 in the first and second embodiments, the substrate sheet 5 is molded by use of a vacuum molding method. However, the substrate sheet 5 may be molded by use of a press molding method. FIGS. 6A to 6C are views to describe the procedure of a manufacturing method for a composite member according to the present embodiment.

Note that, in the following description, descriptions that have been made in the manufacturing methods for the composite member 1 in the first and second embodiments are omitted, and a member equivalent to a member in the first and second embodiments will be described with the same reference sign as the reference sign assigned to the member in the first and second embodiments. Further, the substrate sheet 5 and the composite member 1 of the present embodiment are the same as the substrate sheet 5 and the composite member 1 of the first embodiment, and therefore, illustrations corresponding to FIGS. 1A and 1E are omitted in FIGS. 6A to 6C.

In the manufacturing method for the composite member 1 in the present embodiment, the substrate sheet 5 is molded and the foaming resin layer 4 is formed by use of a first mold 31 as illustrated in FIGS. 6A to 6C. More specifically, the first mold 31 includes an upper mold 32, a lower mold 33, and a slide core 34.

As illustrated in FIG. 6A, the upper mold 32 includes a recessed cavity surface 32a provided on a bottom face of the upper mold 32 so as to correspond to an outer shape of a component for which the composite member 1 is used, and a suction path (not shown). A first end of the suction path reaches the cavity surface 32a, and a second end of the suction path is connected to a suction pump.

The lower mold 33 includes a storage portion 33a in which the slide core 34 is stored, and an injection path 33b for foaming resin, and an injection pipe 35 is passed through the injection path 33b. A first end of the injection pipe 35 projects from a bottom face of the lower mold 33, and a second end of the injection pipe 35 is connected to an injection pump for the foaming resin.

The slide core 34 includes a first part 34a, a second part 34b, a third part 34c configured to connect the first part 34a to the second part 34b, the third part 34c being movable in the up-down direction. A cavity surface 34d is formed by top faces of the first part 34a, the second part 34b, and the third part 34c. A through-hole 34e through which the injection pipe 35 is passed is formed in the second part 34b.

Such a slide core 34 is configured such that the first part 34a, the second part 34b, and the third part 34c are moved in the up-down direction by a drive mechanism (not shown). More specifically, when the first part 34a, the second part 34b, and the third part 34c are moved downward by the drive mechanism, the first part 34a and the third part 34c are stored in the storage portion 33a of the lower mold 33, and the second part 34b is placed on a top face of the lower mold 33. At this time, the top face of the first part 34a and the top face of the third part 34c are placed generally at the same height, so that the cavity surface 34d of the slide core 34 has a shape corresponding to an inner shape of the component for which the composite member 1 is used.

In the meantime, when the first part 34a, the second part 34b, and the third part 34c are moved upward by the drive mechanism, the first part 34a, the second part 34b, and the third part 34c are placed so as to project at a preset height from the lower mold 33. At this time, the top face of the second part 34b and the top face of the third part 34c are placed generally at the same height, so that the cavity surface 34d of the slide core 34 has a shape corresponding to the outer shape of the component for which the composite member 1 is used. Note that the configuration of the slide core 34 can be changed appropriately.

In a case where the substrate sheet 5 is molded by use of such a first mold 31, the slide core 34 is moved upward by the drive mechanism from the storage portion 33a of the lower mold 33. Then, the heated substrate sheet 5 is placed between the upper mold 32 and the lower mold 33 or the substrate sheet 5 is heated after the substrate sheet 5 is placed between the upper mold 32 and the lower mold 33, and the upper mold 32 and the lower mold 33 relatively come close to each other so that the substrate sheet 5 is sandwiched between the cavity surface 32a of the upper mold 32 and the cavity surface 34d of the slide core 34, as illustrated in FIG. 6A. Hereby, the substrate sheet 5 is molded.

Subsequently, while the air is sucked up through the suction path of the upper mold 32 so as to maintain a state where the substrate sheet 5 is adsorbed and held by the cavity surface 32a of the upper mold 32, the slide core 34 is moved downward by the drive mechanism so that the foaming resin layer 4 is formed on the bottom face of the substrate sheet 5, as illustrated in FIG. 6B. Hereby, a cavity 31a of the first mold 31, surrounded by the cavity surface 32a of the upper mold 32 and the cavity surface 34d of the slide core 34, is formed. At this time, an upper end of the injection pipe 35 and the cavity surface 34d of the slide core 34 are placed generally at the same height.

Subsequently, while a state where the substrate sheet 5 is adsorbed and held by the cavity surface 32a of the upper mold 32 is maintained, the foaming resin is injected into the cavity 31a of the first mold 31 through the injection pipe 35, and hereby, the foaming resin layer 4 is formed, as illustrated in FIG. 6C. That is, the first mold 31 of the present embodiment is also used as a second mold to be used at the time of forming the foaming resin layer.

At this time, the substrate sheet 5 should be adsorbed and held by the cavity surface 32a of the upper mold 32 at least until the injection of the foaming resin is started. As such, the substrate sheet 5 after the molding is adsorbed and held by the cavity surface 32a of the upper mold 32 at least after the molding of the substrate sheet 5 has been completed but before the formation of the foaming resin layer 4 is started.

On this account, even in a case where the substrate sheet 5 is a thin sheet material having a flexibility, the shape of the substrate sheet 5 is maintained by the upper mold 32 after the molding of the substrate sheet 5 has been completed but before the formation of the foaming resin layer 4 is started. Accordingly, it is possible to restrain deformation of the substrate sheet 5 at the time when the molding step of the substrate sheet 5 is shifted to the forming step of the foaming resin layer 4, so that the composite member 1 can be manufactured with accuracy.

After that, the upper mold 32 and the lower mold 33 are opened, and the composite member 1 as a laminated body is taken out. Here, the manufacture of the composite member 1 is finished.

As such, in the manufacturing method for the composite member 1 in the present embodiment, the molding step of the substrate sheet 5 and the forming step of the foaming resin layer 4 can be performed continuously by use of the first mold 31. That is, in the manufacturing method for the composite member 1 in the present embodiment, in order to mold the substrate sheet 5, the upper mold 32 and the lower mold 33 relatively come close to each other to be closed, and the foaming resin layer 4 is formed by use of a state where the upper mold 32 and the lower mold 33 are closed.

On this account, in the manufacturing method for the composite member 1 in the present embodiment, the molding step of the substrate sheet 5 and the forming step of the foaming resin layer 4 can be performed further continuously, as compared with the manufacturing methods for the composite member 1 in the first and second embodiments. On this account, in the manufacturing method for the composite member 1 in the present embodiment, it is possible to shorten the manufacturing time for the composite member 1 and to improve the productivity of the composite member 1, as compared with the manufacturing methods for the composite member 1 in the first and second embodiments.

Besides, the first mold 31 of the present embodiment is also used as the second mold for forming the foaming resin layer, and therefore, it is not necessary to prepare the second mold separately, thereby making it possible to restrain the manufacturing cost of the composite member 1.

### Fourth Embodiment

In the manufacturing methods for the composite member 1 in the first to third embodiments, for example, in a case where the substrate sheet 5 is formed by forming the coating layer 3 on the resin sheet 2 in the coating facility in the manufactory for the composite member 1, and after the substrate sheet 5 is dried by heat, the substrate sheet 5 thus dried by heat is transferred to the molding facility distanced from the coating facility in the manufactory so that the molding step of the substrate sheet 5 and the forming step of the foaming resin layer 4 are performed, the temperature of the substrate sheet 5 changes as illustrated in FIG. 4.

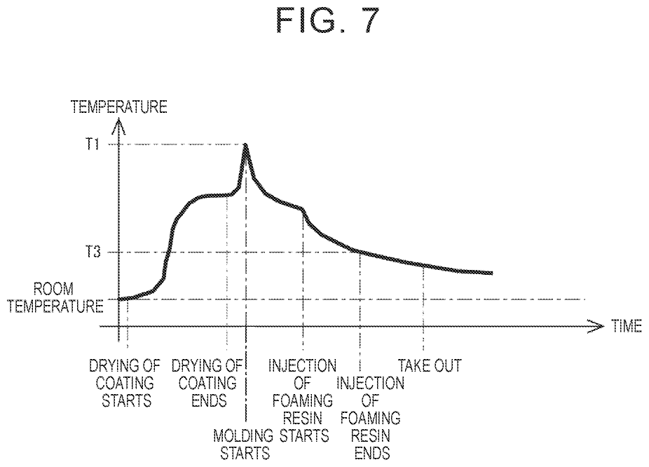

In the meantime, for example, in a case where the substrate sheet 5 is formed by forming the coating layer 3 on the resin sheet 2 in the coating facility in the manufactory for the composite member 1, and after the substrate sheet 5 is dried by heat, the substrate sheet 5 thus dried by heat is transferred to the molding facility adjacent to the coating facility in the manufactory so that the molding step of the substrate sheet 5 and the forming step of the foaming resin layer 4 are performed, the temperature of the substrate sheet 5 changes as described below. FIG. 7 is a view to describe a temperature change in the substrate sheet in the manufacturing method for the composite member according to the present embodiment.

First, the temperature of the substrate sheet 5 rises at the time when the substrate sheet 5 is dried by heat. When the drying of the substrate sheet 5 by heat is completed, the substrate sheet 5 is transferred from the coating facility to the molding facility. However, since the coating facility is adjacent to the molding facility, a decrease of the temperature of the substrate sheet 5 is small in comparison with a case where the coating facility is distanced from the molding facility.

Then, in order to mold the substrate sheet 5, the substrate sheet 5 is heated to the preset temperature T1, and when the molding of the substrate sheet 5 is started, heating of the substrate sheet 5 is stopped, so that the temperature of the substrate sheet 5 decreases.

After that, the molding step of the substrate sheet 5 is shifted to the forming step of the foaming resin layer 4. In the manufacturing method for the composite member 1 in the present embodiment, after the molding step of the substrate sheet 5, the substrate sheet 5 is not transferred to a facility different from the molding facility in order that the substrate sheet 5 is to be unmolded and the forming step of the foaming resin layer 4 is to be performed, for example.

On this account, also in the manufacturing method for the composite member 1 in the present embodiment, the temperature of the substrate sheet 5 does not decrease to the room temperature of the manufactory between the molding step of the substrate sheet 5 and the forming step of the foaming resin layer 4, and the temperature after the molding of the substrate sheet 5 is started but before the injection of the foaming resin is completed does not become lower than a temperature T3 obtained at the time when the injection of the foaming resin has been completed, as illustrated in FIG. 7.

In such a manufacturing method for the composite member 1, the substrate sheet 5 can be molded by use of heat of the substrate sheet 5 at the time when the substrate sheet 5 is dried by heat, and the foaming resin layer 4 can be formed by use of heat of the substrate sheet 5 at the time when the substrate sheet 5 is molded. Accordingly, it is possible to restrain an energy loss.

### Fifth Embodiment

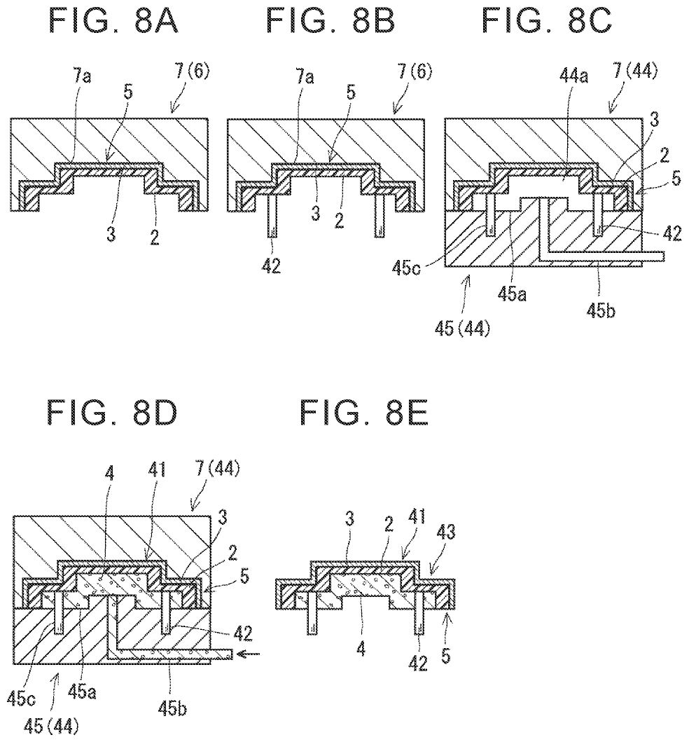

FIGS. 8A to 8E are views to describe the procedure of a manufacturing method for a composite member according to the present embodiment. Note that, in the following description, descriptions that have been made in the manufacturing methods for the composite member 1 in the first to fourth embodiments are omitted, and a member equivalent to a member in the first to fourth embodiments will be described with the same reference sign as the reference sign assigned to the member in the first to fourth embodiments. Further, the substrate sheet 5 of the present embodiment is the same as the substrate sheet 5 of the first embodiment, and therefore, illustrations corresponding to FIG. 1A are omitted in FIGS. 8A to 8E.

In the present embodiment, a composite member 43 in which a laminated body 41 is integrated with a functional member 42 as illustrated in FIG. 8E is manufactured. More specifically, as illustrated in FIG. 8A, the manufacturing method in the present embodiment is the same as the manufacturing method for the composite member 1 in the first embodiment until the substrate sheet 5 is molded by use of the recessed mold 7. As illustrated in FIG. 8B, the functional member 42 is joined to the bottom face of the substrate sheet 5 in a state where the substrate sheet 5 is held by the cavity surface 7a of the recessed mold 7 after the molding of the substrate sheet 5.

The functional member 42 is, for example, an integrated component of a reinforcement and a stay, but the functional member 42 should be a general functional member made of metal, resin, or the like. Further, the functional member 42 may be joined to the substrate sheet 5 by means of bonding, fusion, fastening, or the like, for example.

Subsequently, as illustrated in FIG. 8C, a second mold 44 is closed so as to form the foaming resin layer 4 on the bottom face 2b of the resin sheet 2. The second mold 44 of the present embodiment includes the recessed mold 7 and a lower mold 45. That is, also in the present embodiment, the recessed mold 7 is commonly used for the first mold 6 and the second mold 44.

The lower mold 45 is generally the same as the lower mold 9 in the first embodiment, and the lower mold 45 includes a cavity surface 45a provided on a top face of the lower mold 45 so as to correspond to an inner shape of a component for which the composite member 43 is used, and an injection path 45b. At this time, the lower mold 45 may include a housing portion 45c for the functional member 42 depending on the shape of the functional member 42.

Subsequently, as illustrated in FIG. 8D, foaming resin is injected into a cavity 44a of the second mold 44 through the injection path 45b of the lower mold 45, so that the foaming resin layer 4 is formed on the bottom face 2b of the resin sheet 2. Hereby, the laminated body 41 in which the foaming resin layer 4, the resin sheet 2, and the coating layer 3 are laminated from bottom to top, and the functional member 42 are formed in an integrated manner.

After that, the recessed mold 7 and the lower mold 45 are opened, and the composite member 43 in which the laminated body 41 and the functional member 42 are formed in an integrated manner as illustrated in FIG. 8E is taken out. Thus, the manufacture of the composite member 43 is finished.

As such, in the manufacturing method for the composite member 43 in the present embodiment, while the laminated body 41 is formed, the functional member 42 can be attached to the laminated body 41. Hereby, the composite member 43 including the functional member 42 can be easily manufactured at low cost.

The disclosure is not limited to the above embodiments, and various modifications can be made within a range that does not deviate from the gist of the disclosure.

For example, in the above embodiments, the substrate sheet 5 is a thin sheet material having a flexibility, and the substrate sheet 5 after the molding has a rigidity with which the substrate sheet 5 cannot maintain its shape by itself at the time when the substrate sheet 5 is unmolded. However, the substrate sheet 5 after the molding may have a rigidity with which the substrate sheet 5 can maintain its shape by itself at the time when the substrate sheet 5 is unmolded. In this case, it is not necessary to hold the substrate sheet 5 after the molding by the cavity surface of the first mold or the second mold after the molding of the substrate sheet 5 has been completed but before the formation of the foaming resin layer 4 is started. On this account, it is not necessary to perform the molding step of the substrate sheet 5 and the forming step of the foaming resin layer 4 continuously. However, even in a case where the substrate sheet 5 has a rigidity with which the substrate sheet 5 can maintain its shape by itself, it is preferable that the substrate sheet 5 after the molding be held by the cavity surface of the first mold or the second mold and the molding step of the substrate sheet 5 and the forming step of the foaming resin layer 4 be performed continuously.

For example, in the above embodiments, the substrate sheet 5 is adsorbed by the cavity surface of the first mold or the second mold and held by the cavity surface. However, holding means is not limited to adsorption, and the substrate sheet 5 may be held by static electricity or the like.

For example, in the above embodiments, the substrate sheet 5 is not heated at the time when the foaming resin is injected. However, the substrate sheet 5 may be heated at the time when the foaming resin is injected. Further, the coating facility and the molding facility are provided in the manufactory, but the coating facility and the molding facility may be provided in separate buildings. However, in order to effectively use heat generated when the coating layer 3 of the substrate sheet 5 is dried by heat, it is preferable that the coating facility and the molding facility be provided close to each other.

What is claimed is:

1. A manufacturing method for a composite member, the manufacturing method comprising:
a step of forming a substrate sheet by forming a coating layer on a first surface of a resin sheet and drying the substrate sheet by heat;
a step of molding the substrate sheet by use of a first mold by heating the substrate sheet; and
a step of forming a foaming resin layer on a second surface of the resin sheet by use of a second mold after the substrate sheet is molded, the second surface being an opposite side from the first surface of the resin sheet.

2. The manufacturing method according to claim 1, wherein:
the substrate sheet after the molding has a rigidity with which the substrate sheet does not maintain a shape of the substrate sheet by itself when the substrate sheet is unmolded from the first mold; and
the substrate sheet after the molding is held by a cavity surface of the first mold or the second mold at least after the molding of the substrate sheet has been completed but before the formation of the foaming resin layer is started.

3. The manufacturing method according to claim 1, wherein a temperature of the substrate sheet after the molding of the substrate sheet is started but before injection of foaming resin into a cavity of the second mold to form the foaming resin layer is completed does not become lower than a temperature of the substrate sheet when the injection of the foaming resin has been completed.

4. The manufacturing method according to claim 1, further comprising a step of joining a functional member to the second surface of the resin sheet after the substrate sheet is molded, wherein, in the step of forming the foaming resin layer, the foaming resin layer is formed by injecting foaming resin into a cavity of the second mold in a state where the substrate sheet to which the functional member is joined is placed inside the cavity of the second mold.
